(19) United States
(12) Patent Application Publication
(10) Pub. No.: US 2004/0068031 A1
(43) Pub. Date: Apr. 8, 2004

(54) Oil based ink composition for inkjet printer and method for production thereof

(75) Inventors: Seiji Horie, Shizuoka (JP); Yutaka Sakasai, Shizuoka (JP)

Correspondence Address: BURNS DOANE SWECKER & MATHIS L L P, POST OFFICE BOX 1404, ALEXANDRIA, VA, 22313-1404, US

(73) Assignee: FUJI PHOTO FILM CO., LTD.

(21) Appl. No.: 10/668,152

(22) Filed: Sep. 24, 2003

(30) Foreign Application Priority Data
Sep. 27, 2002 (JP) P. 2002-282942

(51) Int. Cl. C03C 17/00; C09D 5/00

(52) U.S. Cl. 523/160; 523/161

(57) ABSTRACT

An oil based ink composition for inkjet printer comprising a coloring agent and a binder resin in a non-aqueous dispersion medium, wherein the binder resin comprises a copolymer, which is insoluble in the non-aqueous dispersion medium and comprises (a) a monofunctional monomer A containing an aliphatic cyclic hydrocarbon group having from 5 to 30 carbon atoms and (b) a monofunctional monomer B, which is capable of copolymerizing with the monofunctional monomer A and a homopolymer of which is soluble in the non-aqueous dispersion medium.

### FIELD OF THE INVENTION

The present invention relates to an oil based ink composition for use in an inkjet recording device, which discharges ink to form letters or images on an ink receiving medium, for example, recording paper. In particular, the invention relates to an oil based ink composition comprising a pigment dispersion in a non-aqueous dispersion medium and a method for the production thereof.

### BACKGROUND OF THE INVENTION

Hitherto, inkjet recording systems are broadly divided into two groups, a continuous type and an on-demand type. In the continuous type, ink droplets are continuously generated, charge amounts of the ink droplets used for the formation of image are controlled, and the ink droplets are passed through a electrostatic field formed between deflecting electrodes to control the flight passages thereof. In the on-demand type, ink is discharged only when printing is carried out.

The mainstream inks to be used for such inkjet recording systems are inks prepared by dissolving various water-soluble dyes in water or a solvent composed of water and a water-soluble organic solvent and optionally adding various additives thereto (hereinafter referred to as “aqueous dye ink”). However, in the case where printing is practically carried out using the aqueous dye ink, many drawbacks are encountered in that the ink blurs on recording paper depending on the kind of paper, whereby high-quality print cannot be obtained, in that a formed recorded image is poor in water resistance and light fastness, in that drying of ink on recording paper is so slow that streaks occur, and in that a recorded image is deteriorated due to color mixing (color turbidity or color unevenness occurred on the interface when dots having different colors are printed adjacent to each other).

For improving the water resistance and light fastness of recorded image that are the problems of aqueous dye ink as described above, there have been made various proposals to apply pigment based ink comprising fine particles of pigment dispersed in an aqueous dispersion medium or a non-aqueous dispersion medium to the inkjet recording system. For example, inks for inkjet printer comprising a pigment dispersed in a solvent mainly composed of water are proposed (refer to Patent Documents 1 to 5 shown below). However, there is a problem in that since the pigment is insoluble in the medium, dispersion stability of the ink is ordinarily poor to likely cause clogging in a nozzle section.

On the other hand, ink comprising a pigment dispersed in a non-polar insulating solvent (hereinafter referred to as “oil based pigment ink”) has advantages in that it is less in blur due to good absorption into paper and in that a recorded image is good in water resistance. For example, oil based pigment ink in which pigment is finely divided with an alcoholamide based dispersant (refer to Patent Document 6 shown below) and oil based pigment ink in which pigment is finely divided with a sorbitan based dispersant (refer to Patent Document 7 shown below) are proposed. However, such inks still have a problem in that the clogging of ink in a nozzle section is liable to occur, because it is not sufficient to uniformly disperse the pigment particles in the state of fine particles in the non-polar insulating solvent and the dispersion stability thereof is inferior. In addition, there is a severe defect in that the ink is poor in scratch resistance because the pigment itself does not have a fixing ability on recording paper.

For resolving these problems, there are proposed resin dissolution type oil based inks using a resin soluble in the non-polar insulating solvent as both a fixing agent and a pigment dispersant. For example, ink containing a terpene phenol based resin as the above-described resin is proposed in Patent Document 8 (JP-A-3-234772) (the term “JP-A” as used herein means an “unexamined published Japanese patent application”). However, the ink is still insufficient with respect to the dispersion stability of pigment and is questionable in its reliability. Moreover, since the resin is dissolved in the non-polar solvent, the resin does not remain in an amount sufficient for completely fixing the pigment on recording paper, so that water resistance and scratch resistance are not sufficient.

Further, inks containing an alicyclic saturated hydrocarbon as a resin soluble in the non-polar insulating solvent are proposed in Patent Document 9 (JP-A-5-202329) and Patent Document 10 (JP-A-5-320551). However, the inks are insufficient in the dispersion stability and scratch resistance and when the amount of resin added is increased in order to ensure the scratch resistance, viscosity of the ink increases to cause a problem in that the ink cannot be discharged.

Thus, for obtaining high-level scratch resistance, it is proposed to coat pigment particles with a resin insoluble or semi-soluble in the non-polar insulating solvent. For example, oil based ink comprising a pigment coated with a resin by microencapsulation, etc. is proposed in Patent Document 11 (JP-A-4-25574). However, since it is difficult to uniformly disperse the pigment-included resin particles in the state of fine particle and the dispersion stability thereof is not sufficient, there is a problem in its reliability as ink. In addition, in recent years, high image quality of photographic image is attained by ordinary inkjet printers using the aqueous dye ink. With respect to the pigment ink, for increasing color forming property and transparency, it is required to make pigment fine as far as possible and to keep the dispersion state thereof stably.

In contrast, however, when the pigment is made finer, crushing of primary pigment particles occurs simultaneously with pulverization of the pigment. Further, since cohesive energy simultaneously becomes large due to increase of surface energy, re-coagulation of the pigment particles is apt to occur. As a result, a problem occurs in that storage stability of the finely divided pigment dispersion is impaired. As described above, with respect to the pigment dispersion used in oil based pigment ink for inkjet printer, pulverization at a higher level is demanded. However, high-level techniques are required for dispersing pigment in the state of fine particle, and it is very difficult to increase the dispersion stability thereof. Therefore, development of oil based pigment ink capable of meeting the above-described requirements has been desired.

It is required for the binder resin for dispersing and coating a coloring agent to ordinarily have characteristics, for example, (1) that it can sufficiently coat the surface of pigment to form a colored admixture, which reveals an appropriate fluidity upon heat, etc., (2) that it can well disperse a coloring agent in a dispersion medium by coating, (3) that it is as transparent as possible, and (4) that it firmly adheres to a recording medium by fixing to exert sufficient scratch resistance.

In view of the characteristics required to the binder resin, for example, the function of being adsorbed onto a coloring agent to well disperse the coloring agent in the dispersion medium and the function of firmly adhering to a recording medium to exert sufficient scratch resistance, it is ideal that the binder resin has as fundamental components a component solvating with the dispersion medium, a component hardly solvating with the dispersion medium and a component having a polar group. However, it is difficult to find out the binder resin that satisfies all of the characteristics described above.

Patent Document 1: JP-A-2-255875

Patent Document 2: JP-A-3-76767

Patent Document 3: JP-A-3-76768

Patent Document 4: JP-A-56-147871

Patent Document 5: JP-A-56-147868

Patent Document 6: JP-A-57-10660

Patent Document 7: JP-A-57-10661

Patent Document 8: JP-A-3-234772

Patent Document 9: JP-A-5-202329

Patent Document 10: JP-A-5-320551

Patent Document 11: JP-A-4-25574

### SUMMARY OF THE INVENTION

Therefore, an object of the invention is to provide an oil based ink composition for inkjet printer in which a pigment is uniformly dispersed in the state of fine particle and dispersion stability of the pigment dispersion is excellent, and which has high discharge stability free from the occurrence of clogging in a nozzle section.

Another object of the invention is to provide an oil based ink composition for inkjet printer, which has excellent drying property on recording paper, excellent water resistance and light fastness of recorded image, and high-level scratch resistance.

A further object of the invention is to provide an oil based ink composition for inkjet printer, which is capable of providing a large number of prints having clear color images of good quality without ink blur.

Other objects of the invention will become apparent from the following description.

As a result of the intensive investigations, it has been found that the above-described objects can be attained by the following constructions:

(1) An oil based ink composition for inkjet printer comprising a coloring agent and a binder resin in a non-aqueous dispersion medium, wherein the binder resin comprises a copolymer, which is insoluble in the non-aqueous dispersion medium and comprises (a) a monofunctional monomer A containing an aliphatic cyclic hydrocarbon group having from 5 to 30 carbon atoms and (b) a monofunctional monomer B, which is capable of copolymerizing with the monofunctional monomer A and a homopolymer of which is soluble in the non-aqueous dispersion medium.

(2) The oil based ink composition for inkjet printer as described in item (1) above, wherein the monofunctional monomer A containing an aliphatic cyclic hydrocarbon group having from 5 to 30 carbon atoms is a monomer represented by the following formula (I):

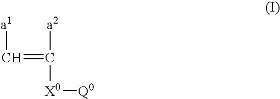

In formula (I), X^{o} represents a connecting group selected from —COO—, —OCO—, —(CH₂)ₖ—OCO—, —(CH₂)ₖ—COO—, —COO(CH₂)ₖ—, —COO(CH₂O)ₖ—, —CONHCOO—, —CONHCONH—, —O—, and a combination of these groups; k represents an integer of from 1 to 3; a¹ and a², which may be the same or different, each represent a hydrogen atom, a halogen atom, a cyano group, a hydrocarbon group, —COO—Z¹ or —COO—Z¹ connected through a hydrocarbon group; Z¹ represents a hydrogen atom or an hydrocarbon group; and Q⁰ represents an aliphatic cyclic hydrocarbon group having from 5 to 30 carbon atoms.

(3) The oil based ink composition for inkjet printer as described in item (1) or (2) above, which further comprises a dispersant for pigment.

(4) The oil based ink composition for inkjet printer as described in any one of items (1) to (3) above, wherein the coloring agent is coated with the binder resin to form a colored admixture and the colored admixture has the maximum particle size of not more than 1 μm and an average particle size of from 0.01 to 0.5 μm.

(5) Amethod for the production of an oil based ink composition for inkjet printer comprising a coloring agent and a binder resin in a non-aqueous dispersion medium, wherein the binder resin comprises a copolymer, which is insoluble in the non-aqueous dispersion medium and comprises (a) a monofunctional monomer A containing an aliphatic cyclic hydrocarbon group having from 5 to 30 carbon atoms and (b) a monofunctional monomer B, which is capable of copolymerizing with the monofunctional monomer A and a homopolymer of which is soluble in the non-aqueous dispersion medium, and the method includes a step of coating the coloring agent with the binder resin.

### DETAILED DESCRIPTION OF THE INVENTION

The invention will be described in detail below.

The binder resin for use in the invention is a copolymer that comprises (a) at least one monofunctional monomer A containing an aliphatic cyclic hydrocarbon group having from 5 to 30 carbon atoms and (b) at least one monofunctional monomer B, which is capable of copolymerizing with the monofunctional monomer A and becomes soluble in the non-aqueous dispersion medium upon polymerization, is insoluble in the non-aqueous dispersion medium, is in the form of wax or solid at ambient temperature, and has a function of fixing the coloring agent after the image formation on a recording medium. The copolymer used in the invention is a liner random copolymer comprises the monofunctional monomer A and the monofunctional monomer B.

Now, (a) the monofunctional monomer A containing an aliphatic cyclic hydrocarbon group having from 5 to 30 carbon atoms is described below.

The monofunctional monomer A containing an aliphatic cyclic hydrocarbon group having from 5 to 30 carbon atoms is not particularly restricted but preferably a compound represented by formula (I) described above.

In formula (I), Xo represents a connecting group selected from —COO—, —OCO—, —(CH₂)ₖ—OCO—, —(CH₂)ₖ—COO—, —COO(CH₂)ₖ—, —COO(CH₂O)ₖ—, —CONHCOO—, —CONHCONH—, —O—, and a combination of these groups, wherein k represents an integer of from 1 to 3.

a¹ and a², which may be the same or different, each preferably represent a hydrogen atom, a halogen atom (for example, a chlorine atom or a bromine atom), a cyano group, an alkyl group having from 1 to 3 carbon atoms (for example, a methyl group, an ethyl group or a propyl group), —COO—Z¹, or —COO—Z¹ connected through a hydrocarbon group, wherein Z¹ represents a hydrogen atom or an hydrocarbon group, which may be substituted, and preferably a hydrogen atom, an alkyl group having from 1 to 18 carbon atoms, an alkenyl group, an aralkyl group, an alicyclic group or an aryl group, each of these groups maybe substituted. The hydrocarbon group for connecting —COO—Z¹ is preferably an alkylene group, for example, —CH₂—.

Q⁰ represents an aliphatic cyclic hydrocarbon group having from 5 to 30 carbon atoms.

The aliphatic cyclic hydrocarbon group is a hydrocarbon group constituting a cyclic structure having from 5 to 30 carbon atoms including, for example, monocyclic, polycyclic, bridged cyclic and spiro cyclic structures.

Specifically, groups containing a monocyclo, bicyclo, tricyclo, tetracyclo or pentacyclo structure and having not less than 5 carbon atoms are enumerated. The aliphatic cyclic hydrocarbon group preferably has from 6 to 25 carbon atoms.

Examples of structure of the alicyclic portion in the aliphatic cyclic hydrocarbon group (hereinafter also referred to as an alicyclic hydrocarbon group) are set forth below. In the examples, each structure may contain a non-conjugated double bond.

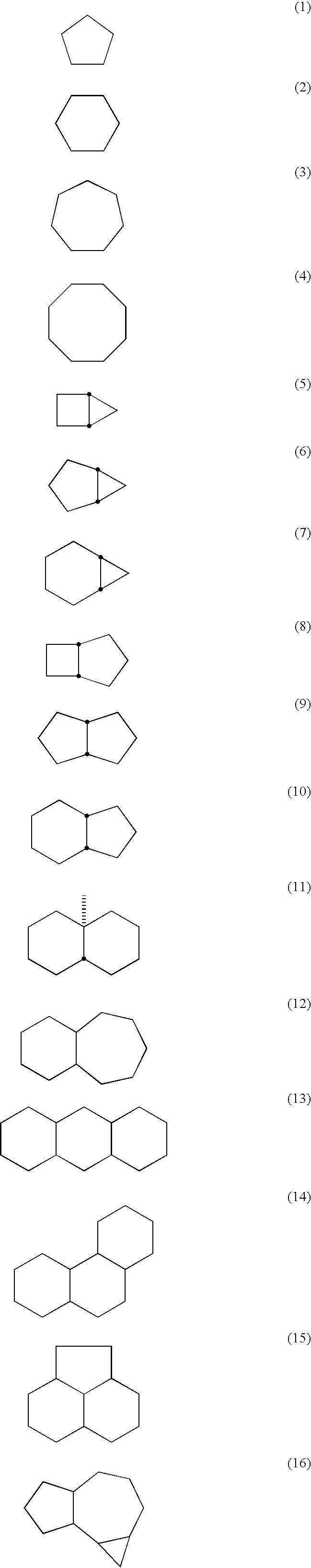

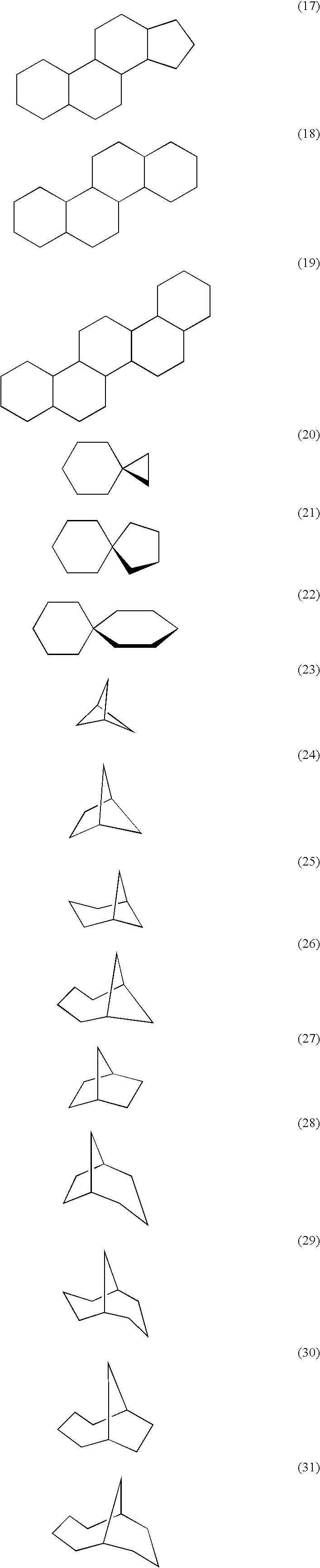

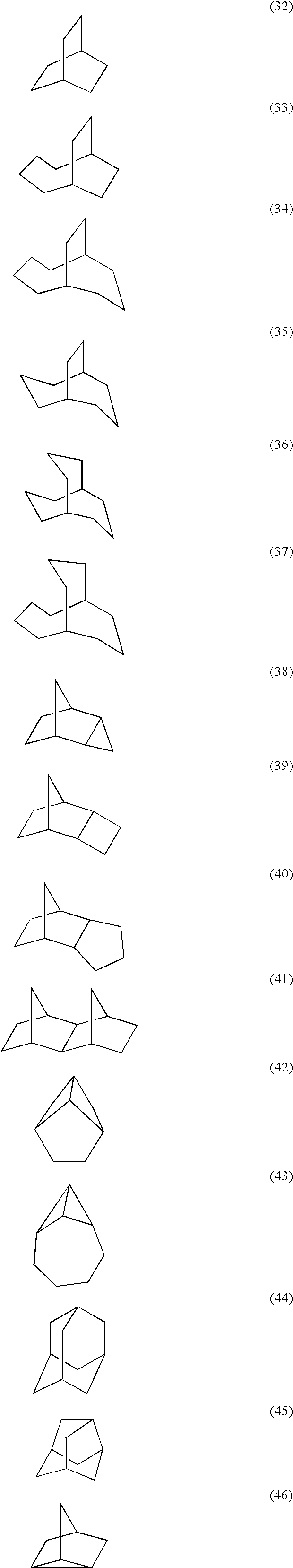

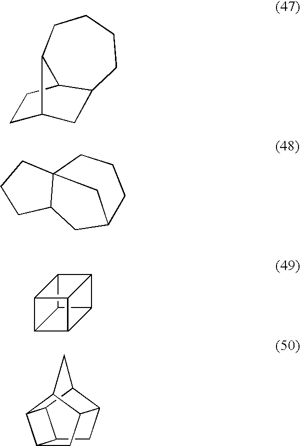

The alicyclic hydrocarbon group may have one or more substituents. Examples of the substituent on the alicyclic hydrocarbon group include an alkyl group, a substituted alkyl group, a halogen atom (for example, a fluorine atom, a chlorine atom, a bromine atom or an iodine atom), a cyano group, a hydroxy group, a nitro group, an alkoxy group, a carboxy group, an amido group, an acyl group and an alkoxycarbonyl group.

The alkyl group is preferably a lower alkyl group, for example, a methyl group, an ethyl group, a propyl group, an isopropyl group, a butyl group, a pentyl group or a hexyl group, and more preferably a methyl group, an ethyl group, a propyl group or a butyl group. Examples of the substituent for the substituted alkyl group include a hydroxy group, a halogen atom and an alkoxy group.

The alkoxy group or that in the alkoxycarbonyl group is preferably an alkoxy group having from 1 to 4 carbon atoms, for example, a methoxy group, an ethoxy group, a propoxy group or a butoxy group.

The amido group includes preferably a monoalkylamido group or a dialkylamido group. The alkyl group has the same meaning as the alkyl group defined above.

The acyl group includes an aliphatic group having from 1 to 6 carbon atoms (for example, a methyl group, an ethyl group, a propyl group, an isopropyl group, a butyl group, a pentyl group or a hexyl group).

The substituents for the alicyclic hydrocarbon group are not restricted to those described above and any substituent is preferably used as long as a homopolymer made of monomer A corresponding to (a) having the substituent is insoluble in the non-aqueous solvent.

Now, (b) the monofunctional monomer B, which is capable of copolymerizing with the monofunctional monomer A described above and a homopolymer of which is soluble in the non-aqueous dispersion medium is described below.

The monofunctional monomer B is any monomer as long as it is capable of copolymerizing with the monofunctional monomer A and a homopolymer of which is soluble in the non-aqueous dispersion medium.

Specifically, the monofunctional monomer B includes a monomer represented by the following formula (II):

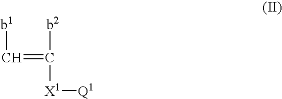

In formula (II), X¹, b¹ and b² have the same meanings as X⁰, a¹ and a² defined in formula (I), respectively.

In formula (II), Q¹ represents an aliphatic group having not less than 8 carbon atoms. The aliphatic group may be a straight chain or branched aliphatic group, may have a substituent, for example, a halogen atom, a hydroxy group, an amino group or an alkoxy group, or may contain a hetero atom, for example, an oxygen atom, a sulfur atom or a nitrogen atom between the carbon atom-carbon atom bond in the main chain thereof. Specific examples of the aliphatic group include an octyl group, a decyl group, a dodecyl group, a tridecyl group, a tetradecyl group, a hexadecyl group, an octadecyl group, a docosyl group, a dodecenyl group, a hexadecenyl group, an oleyl group, a linoleyl group and a docosenyl group.

Specific examples of the monofunctional monomer containing a long chain aliphatic group having not less than 8 carbon atoms and capable of copolymerizing with the monofunctional monomer A include esters of unsaturated carboxylic acids (for example, acrylic acid, α-fluoroacrylic acid, α-chloroarylic acid, α-cyanoacrylic acid, methacrylic acid, crotonic acid, maleic acid or itaconic acid) containing an aliphatic group having from 10 to 32 carbon atoms in total; amides of the above-described unsaturated carboxylic acids; vinyl esters or allyl esters of higher fatty acids (examples of the higher fatty acid include lauric acid, myristic acid, stearic acid, oleic acid, linolic acid and behenic acid); and vinyl ethers in which an aliphatic group having from 10 to 32 carbon atoms in total is bound to an oxygen atom (examples of the aliphatic group include those described for the unsaturated carboxylic acid ester above); and vinyl acetate.

The copolymer for the binder resin used in the invention may contain other monomer C together with (a) the monofunctional monomer A containing an aliphatic cyclic hydrocarbon group having from 5 to 30 carbon atoms and (b) the monofunctional monomer B, which is capable of copolymerizing with the monofunctional monomer A and a homopolymer of which is soluble in the non-aqueous dispersion medium.

The monomer C is any monomer as long as it is capable of copolymerizing with the monofunctional monomers A and B and a binder resin of the copolymer formed is insoluble in the non-aqueous dispersion medium.

Specific examples of the monomer C include a vinyl ester or allyl ester of an aliphatic carboxylic acid having from 1 to 6 carbon atoms (for example, acetic acid, propionic acid, butyric acid or monochloroacetic acid); an alkyl or aryl ester or an alkyl or aryl amide of an unsaturated carboxylic acid (for example, acrylic acid, methacrylic acid, crotonic acid, itaconic acid or maleic acid) wherein the alkyl group has from 1 to 6 carbon atoms, which may be substituted (examples of the alkyl group include a methyl group, an ethyl group, a propyl group, a butyl group, a pentyl group, a 2-chloroethyl group, a 2-bromoethyl group, a 2-hydroxyethyl group, a 2-cyanoethyl group, a 2-nitroethyl group, a 2-methoxyethyl group, a 3-ethoxypropyl group, a 2-phophonoethyl group, a 3-sulfopropyl group, a 2,3-dihydroxypropyl group, a benzyl group, aphenethyl group, a 2-naphthylethyl group, a 2-(N,N-dimethylamino)ethyl group, a 2-(N,N-diethylamino)ethyl group, a 2-methanesulfonylethyl group, a 2-benzenesulfonylethyl group, a 2-carboxyethyl group, a 4-carboxybutyl group, a 3-chloropropyl group, a 2-hydroxy-3-chloropropyl group, a 2-furfurylethyl group, a 2-thienylethyl group or a 2-carboxyamidoethyl group) and the aryl group may be substituted (examples of the aryl group include a phenyl group, a naphthyl group, an anthranyl group, a cyanophenyl group, a chlorophenyl group, a tolyl group, a xylyl group, a mesityl group, a methoxyphenyl group, an acetophenyl group, a methoxycarbonylphenyl group, a carboxyphenyl group or an N,N-dimethylaminomethylphenyl group; a styrene derivative (for example, styrene, vinyltoluene, α-methylstyrene, vinylnaphthalene, chlorostyrene, dichlorostyrene, bromostyrene, vinylbenznecarboxylic acid, chloromethyl-styrene, hydroxymethylstyrene, methoxymethylstyrene, vinylbenzenecarboxamide or vinylbenzenesulfonamide); an unsaturated carboxylic acid (for example, acrylic acid, methacrylic acid, crotonic acid, maleic acid or itaconic acid); a cyclic acid anhydride of maleic acid or itaconic acid; acrylonitrile; methacrylonitrile; and a heterocyclic compound containing a polymerizable double bond group (specifically, the compounds described in Kobunshi Gakkai ed., Polymer Data Handbook-Fundamental Edition-, pages 175 to 184, Baifukan Co., Ltd. (1986), for example, N-vinylpyridine, N-vinylimidazole, N-vinylpyrrolidone, vinylthiophene, vinyltetrahydrofuran, vinyloxazoline, vinylthiazole or N-vinylmorpholine). Two or more of the monomers C may be included in the copolymer for the binder resin.

With the increase of amount of the monofunctional monomer B, a homopolymer of which is soluble in the non-aqueous dispersion medium, used as the constituent component of the copolymer, the copolymer becomes soluble in the non-aqueous dispersion medium. In such a case, it is preferred to use an alkyl (having from 1 to 3 carbon atoms) ester of an unsaturated carboxylic acid as the monomer C. Examples of the alkyl (having from 1 to 3 carbon atoms) ester of an unsaturated carboxylic acid include an alkyl (having from 1 to 3 carbon atoms) ester of acrylic acid, methacrylic acid or crotonic acid, for example, methyl acrylate, methyl methacrylate, methyl crotonate, ethyl acrylate, ethyl methacrylate, ethyl crotonate, propyl acrylate, propyl methacrylate or propyl crotonate.

The copolymer for use in the invention comprises (a) at least one monofunctional monomer A containing an aliphatic cyclic hydrocarbon group having from 5 to 30 carbon atoms and (b) at least one monofunctional monomer B, which is capable of copolymerizing with the monofunctional monomer A and a homopolymer of which is soluble in the non-aqueous dispersion medium. It is preferred that a content of the monomer A is from 30 to 98 parts by weight and a content of the monomer B is from 2 to 70 parts by weight based on 100 parts by weight of the polymer.

More preferably, the content of the monomer A is from 40 to 90 parts by weight and the content of the monomer B is from 5 to 40 parts by weight. A content of the monomer C is preferably not more than 50 parts by weight, and more preferably not more than 40 parts by weight based on 100 parts by weight of the polymer.

A non-aqueous dispersion medium that is used in the oil based ink composition for inkjet printer according to the invention is a non-polar insulating solvent and preferably has a dielectric constant of from 1.5 to 20 and a surface tension of from 15 to 60 mN/m at 25° C. Characteristics further desired for the non-aqueous dispersion medium include that toxicity is low, that flammability is low and that odor is low.

The non-aqueous dispersion media include solvents selected from straight chain or branched aliphatic hydrocarbons, alicyclic hydrocarbons, aromatic hydrocarbons, petroleum naphthas and halogen-substituted products thereof. Examples thereof include hexane, octane, isooctane, decane, isodecane, decalin, nonane, dodecane, isododecane, Isopar E, Isopar G, Isopar H and Isopar L (manufactured by Exxon Chemical Co.), Solutol (manufactured by Phillips Petroleum Co.), IP Solvent (manufactured by Idemitsu Petrochemical Co., Ltd.), and peptroleum naphthas including S.B.R., Shellsol 70 and Shellsol 71 (manufactured by Shell Petrochemical Co., Ltd.) and Vegasol (manufactured by Mobil Oil Corp.). The solvents can be used individually or as a mixture thereof.

The hydrocarbon solvents are preferably high-purity isoparaffinic hydrocarbons having a boiling point in the range of from 150 to 350° C. Examples of commercially available products include Isopar G, Isopar H, Isopar L, Isopar M and Isopar V (trade names, manufactured by Exxon Chemical Co.), Norpar 12, Norpar 13 and Norpar 15 (trade names, manufactured by Exxon Chemical Co.), IP Solvent 1620 and IP Solvent 2028 (trade names, manufactured by Idemitsu Petrochemical Co.,Ltd.), Isosol 300 and Isosol 400 (trade names, manufactured by Nippon Petrochemicals Co., Ltd.), and Amsco OMS and Amsco 460 solvents (trade names, manufactured by American Mineral Spirits Corp.). These products are composed of an aliphatic saturated hydrocarbon having an extremely high purity, and have a viscosity of 3 cSt or less at 25° C., a surface tension of from 22.5 to 28.0 mN/m at 25° C., and a volume resistivity of 10¹⁰ Ω·cm or more at 25° C. Further, these products have characteristics in that they are stable due to low reactivity and highly safe due to low toxicity and in that their odors are low.

The halogen-substituted hydrocarbon solvents include fluorocarbon solvents. Examples thereof include perfluoroalkanes represented by CₙF₂ₙ₊₂, for example, C₇F₁₆ and C₈F₁₈ (for example, Fluorinert PF5080 and Fluoriner PF5070 (trade names, manufactured by Sumitomo 3M Ltd.)), fluorine based inert liquids (for example, Fluorinert FC Series (trade names, manufactured by Sumitomo 3M Ltd.)), fluorocarbons (for example, Krytox GPL Series (trade names, manufactured by DuPont Japan Ltd.)), fleons (for example, HCFC-141b (a trade name, manufactured by Daikin Industries, Ltd.), and iodinated fluorocarbons for example, F(CF₂)₄CH₂CH₂I and F(CF₂)₆I (for example, I-1420 and I-1600 (tradenames, manufactured by Daikin Fine Chemical Laboratory, Ltd.).

As the non-aqueous solvent that is used in the invention, higher fatty acid esters and silicone oils can also be used. Specific examples of the silicone oil include low-viscosity synthetic dimethylpolysiolxanes, which are commercially available, for example, KF96L (a trade name, manufactured by Shin-Etsu Silicones) and SH200 (a trade name, manufactured by Dow Corning Toray Silicone Co., Ltd.).

The silicone oils are not limited to these specific examples. As the dimethylpolysiloxanes, those having a very broad viscosity range are available depending on the molecular weight, but those having a viscosity in the range of from 1 to 20 cSt at 25° C. are preferably used. Similar to the isoparaffinic hydrocarbons, the dimethylpolysiloxanes have a volume resistivity of 10¹⁰ Ω·cm or more at 25° C. and have characteristics, for example, high stability, high safety and odorlessness. Further, the dimethylpolysiloxanes are characterized by having a low surface tension, i.e., the surface tension of from 18 to 21 mN/m at 25° C.

Examples of solvent that can be used together with the above-described non-aqueous dispersion medium include alcohols (for example, methyl alcohol, ethyl alcohol, propyl alcohol, butyl alcohol or fluorinated alcohol), ketones (for example, acetone, methyl ethyl ketone or cyclohexanone), carboxylic acid esters (for example, methyl acetate, ethyl acetate, propyl acetate, butyl acetate, methyl propionate or ethyl propionate), ethers (for example, diethyl ether, dipropyl ether, tetrahydrofuran or dioxane), and halogenated hydrocarbons (for example, methylene dichloride, chloroform, carbon tetrachloride, dichloroethane or methylchloroform).

Now, the coloring agent for use in the invention will be described in detail below.

The coloring agent used in the invention is not particularly restricted and includes any of ordinarily commercially available organic pigments and inorganic pigments.

Examples of the coloring agents that exhibit yellow color include monoazo pigments, for example, C.I. Pigment Yellow 1 (Fast Yellow G, etc.) and C.I. Pigment Yellow 74; disazo pigments, for example, C.I. Pigment Yellow 12 (Disazo Yellow AAA, etc.) and C.I. Pigment Yellow 17; non-benzidine based azo pigments, for example, C.I. Pigment Yellow 180; azo lake pigments, for example, C.I. Pigment Yellow 100 (Tartrazine Yellow Lake, etc.); condensed azo pigments, for example, C.I. Pigment Yellow 95 (Condensed Azo Yellow GR, etc.); acidic dye lake pigments, for example, C.I. Pigment Yellow 115 (Quinoline Yellow Lake, etc.); basic dye lake pigments, for example, C.I. Pigment Yellow 18 (Thioflavin Lake, etc.); anthraquinone based pigments, for example, Flavanthrone Yellow (Y-24); isoindolinone pigments, for example, Isoindolinone Yellow 3RLT (Y-110); quinophthalone pigments, for example, Quinophthalone Yellow (Y-138); isoindoline pigments, for example, Isoindoline Yellow (Y-139); nitroso pigments, for example, C.I. Pigment Yellow 153 (Nickel Nitroso Yellow, etc.); and metal complex azomethine pigments, for example, C.I. Pigment Yellow 117 (Copper Azomethine Yellow, etc.).

Examples of the coloring agents that exhibit magenta color include monoazo pigments, for example, C.I. Pigment Red 3 (Toluidine Red, etc.); disazo pigments, for example, C.I. Pigment Red 38 (Pyrazolone Red B, etc.); azo lake pigments, for example, C.I. Pigment Red 53:1 (Lake Red C, etc.) and C.I. Pigment Red 57:1 (Brilliant Carmine 6B); condensed azo pigments, for example, C.I. Pigment Red 144 (Condensed Azo Red BR, etc.); acidic dye lake pigments, for example, C.I. Pigment Red 174 (Phloxine B Lake, etc.); basic dye lake pigments, for example, C.I. Pigment Red 81 (Rhodamine 6G′ Lake, etc.); anthraquinone based pigments, for example, C.I. Pigment Red 177 (Dianthraquinonyl Red, etc.); thioindigo pigments, for example, C.I. Pigment Red 88 (for example, Thioindigo Bordeaux, etc.); perinone pigments, for example, C.I. Pigment Red 194 (Perinone Red, etc.); perylene pigments, for example, C.I. Pigment Red 149 (Perylene Scarlet, etc.); quinacridone pigments, for example, C.I. Pigment Red 122 (Quinacridone Magenta, etc.); isoindolinone pigments, for example, C.I. Pigment Red 180 (Isoindolinone Red 2BLT, etc.); and arizalin lake pigments, for example, C.I. Pigment Red 83 (Madder Lake, etc.).

Examples of the coloring agents that exhibit cyan color include disazo pigments, for example, C.I. Pigment Blue 25 (Dianisidine Blue, etc.); phthalocyanine pigments, for example, C.I. Pigment Blue 15 (Phthalocyanine Blue, etc.); acidic dye lake pigments, for example, C.I. Pigment Blue 24 (Peacock Blue Lake, etc.) basic dye lake pigments, for example, C.I. Pigment Blue 1 (Victoria Pure Blue BO Lake, etc.); anthraquinone based pigments, for example, C.I. Pigment Blue 60 (Indanthrone Blue, etc.); and alkali blue pigments, for example, C.I. Pigment Blue 18 (Alkali Blue V-5:1).

Examples of the coloring agents that exhibit black color include organic pigments, for example, aniline black based pigments such as BK-1 (Aniline Black), iron oxide pigments, and carbon black pigments, for example, furnace black, lamp black, acetylene black and channel black.

Specific examples of the carbon black pigment include MA-8, MA-10, MA-11, MA-100, MA-220, #25, #40, #260, #2600, #2700B, #3230B, CF-9 and MA-200RB (manufactured by Mitsubishi Chemical Corp.), Printex 75 and Printex 90 (manufactured by Degussa AG), and Monarch 800 and Monarch 1100 (manufactured by Cabot Corp.).

Also, metallic powder is employable for attaining color reproduction, for example, gold, silver or copper color.

The coloring agents for use in the invention are preferably those subjected to surface treatment according to the methods described in Pigment Dispersing Technologies, Chapter 5, Gijutsu Joho Kyokai Co., Ltd in order to easily make it fine particle and to improve dispersibility. Examples of the surface treatment of coloring agent include rosin treatment and flushing resin treatment. Further, ordinarily commercially available processed pigment can be used as the coloring agent. Specific examples of the commercially available processed pigment include Microlith pigments manufactured by Ciba Specialty Chemicals.

With respect to amounts of the coloring agent and the binder resin, the binder resin is used in an amount of 0.3 to 10 parts by weight based on one part by weight of the coloring agent. Preferably, the binder resin is used in an amount of 0.4 to 7 parts by weight based on one part by weight of the coloring agent. More preferably, the binder resin is used in an amount of 0.5 to 5 parts by weight based on one part by weight of the coloring agent. The use of binder resin in an amount of less than 0.3 parts by weight based on one part by weight of the coloring agent is not preferable because of decrease in the effect for dispersing coloring agent at the kneading. On the other hand, when the amount of binder resin used is more than 10 parts by weight based on one part by weight of the coloring agent, the coloring agent concentration in the ink composition decreases to cause reduction of image density so that the desired color density cannot be obtained.

The oil based ink composition for inkjet printer of the invention contains the binder resin and the coloring agent as the main components as described above. It is preferred that the coloring agent is dispersed (admixed) in the binder resin and as a result the coloring agent is coated with the binder resin.

Now, methods for coating the coloring agent with the binder resin to prepare a colored admixture are described below.

The colored admixture is prepared by the following methods:

(1) Method wherein the coloring agent and the binder resin are molten and kneaded at a temperature not lower than a softening point of the binder resin using a kneading machine, for example, a roll mill, a Banbury mixer or a kneader, and after cooling, the mixture is pulverized, thereby obtaining the colored admixture.

(2) Method wherein the binder resin is dissolved in a solvent, the coloring agent is added to the solution, the mixture is subjected to wet type dispersion by a machine, for example, a ball mill, an attritor or a sand grinder, and the dispersion is dried by evaporating the solvent, thereby obtaining the colored admixture, or the dispersion is poured into a non-solvent for the binder resin to precipitate an admixture, followed by drying, thereby obtaining the colored admixture.

(3) Method wherein a water-containing paste (wet cake) of the coloring agent is kneaded together with the binder resin or a solution of the binder resin by a flushing method to substitute the water with the binder resin or the solution of the binder resin, and the mixture is dried by removing the water and the solvent under a reduced pressure, thereby obtaining the colored admixture.

The colored admixture is dispersed in the non-aqueous dispersion medium in fine particulate state according to a step of dispersion. In the dispersion step, it is preferred to use a dispersant for pigment in order to disperse the colored admixture in the fine particulate state and to stabilize the colored admixture in the non-aqueous dispersion medium.

A method of using the colored admixture and the dispersant for pigment includes, for example, the following methods, and any one of these methods can achieve the desired effects.

1. A colored composition obtained by previously mixing the colored admixture with the dispersant for pigment is added and dispersed in the non-aqueous dispersion medium.

2. The colored admixture and the dispersant for pigment are individually added and dispersed in the non-aqueous dispersion medium.

3. Dispersions obtained by separately dispersing the colored admixture and the dispersant for pigment in the non-aqueous dispersion medium are mixed with each other.

4. The colored admixture is dispersed in the non-aqueous dispersion medium and then the dispersant for pigment is added to the resulting colored admixture dispersion.

A machine used for conducting the mixing or dispersion of colored admixture in the non-aqueous dispersion medium includes, for example, a dissolver, a high-speed mixer, a homomixer, a kneader, a ball mill, a roll mill, a sand mill and an attritor.

As the dispersant for pigment for dispersing the colored admixture in the fine particulate state in the non-aqueous dispersion medium, which can be used in the invention, conventional dispersants for pigment applied to the non-aqueous dispersion medium are employed. Any dispersants for pigment can be used as long as they are compatible with the above-described non-polar insulating solvent and can stably disperse the coloring agent in the fine particulate state. Specific examples of the dispersant for pigment include nonionic surfactants, for example, sorbitan fatty acid esters (e.g., sorbitan monooleate, sorbitan monolaurate, sorbitan sesquioleate or sorbitan trioelate), polyoxyethylene sorbitan fatty acid esters (e.g., polyoxyethylene sorbitan monostearate or polyoxyethylene sorbitan monooleate), polyethylene glycol fatty acid esters (e.g., polyethylene glycol monostearate or polyethylene glycol diisostearate), polyoxyethylene alkylphenyl ethers (e.g., polyoxyethylene nonylphenyl ether or polyoxyethylene octylphenyl ether), and aliphatic diethanolamides. Further, as high-molecular dispersants for pigment, high-molecular compounds having a molecular weight of 1,000 or more are preferably used. Examples thereof include styrene-maleic acid resins, styrene-acrylic resins, rosins, BYK-160, BYK-162, BYK-164 and BYK-182 (urethane based high-molecular compounds manufactured by BYK-Chemie), EFKA-47 and LP-4050 (urethane based dispersants manufactured by EFKA), Solsperse 24000 (polyester based high-molecular compound manufactured by Zeneca PLC), and Solsperse 17000 (aliphatic diethanolamide based high-molecular compound manufactured by Zeneca PLC).

Other examples of the high-molecular dispersant for pigment include random copolymers comprising a monomer that solvates with the dispersion medium (for example, lauryl methacrylate, stearylmethacrylate, 2-ethylhexylmethacrylate or cetyl methacrylate), a monomer that hardly solvates with the dispersion medium (for example, methyl methacrylate, ethyl methacrylate, isopropylmethacrylate, styreneorvinyltoluene) and a polar group-containing monomer, and the graft copolymers described in JP-A-3-188469.

Examples of the polar group-containing monomer include an acidic group-containing monomer, for example, acrylic acid, methacrylic acid, itaconic acid, fumaric acid, maleic acid, styrenesufonic acid or an alkali metal salt thereof, and a basic group-containing monomer, for example, dimethylamonoethyl methacrylate, diethylaminoethylmethacrylate, vinylpyridine, vinylpyrrolidine, vinylpiperidine or vinyllactam.

In addition, styrene-butadiene copolymers and the block copolymers of styrene and a long chain alkyl methacrylate as described in JP-A-60-10263 are enumerated. Preferred examples of the dispersant for pigment include the graft copolymers described in JP-A-3-188469.

An amount of the dispersant for pigment used is preferably from 0.1 to 300 parts by weight based on 100 parts by weight of the colored admixture. When the amount of dispersant for pigment added is less than 0.1 parts by weight, the effect for dispersion unpreferably decreases. On the other hand, even when the dispersant for pigment is used more than 300 parts by weight, no further improving effect is achieved.

An average particle size of the colored admixture in the non-aqueous dispersion medium is preferably in a range of from 0.01 to 0.5 μm, and more preferably in a range of from 0.05 to 0.3 μm. The maximum particle size thereof is preferably not more than 1 μm, and more preferably not more than 0.7 μm.

The term “particle size” as used herein means a particle size measured by an ultra-centrifugal automatic particle size distribution analyzer (CAPA700 manufactured by Horiba, Ltd.).

The ink composition of the invention may contain various additives, if desired. The additives to be added to the ink composition are appropriately selected depending on the inkjet system and the material and structure of inkjet ejection head, ink supply portion and ink circulation portion. Examples of the additives are described, for example, in Takeshi Amari supervised, Inkjet Printer-Techniques and Materials, Chapter 17, CMC Publishing Co., Ltd. (1998).

Specific examples thereof include fatty acids (for example, monocarboxylic acid and polybasic acid each having from 6 to 32 carbon atoms, e.g., dodecenylsuccinic acid, butylsuccinic acid, 2-ethylcaproic acid, lauric acid, palmitic acid, elaidic acid, linoreicacid, ricinoleicacid, oleicacid, stearicacid, enanthic acid, naphthenic acid, ethylenediaminetetraacetic acid, abietic acid, tetrahydroabietic acid or hydrogenated rosin), metal salts of resin acid, alkylphthalic acid or alkyl salicylic acid (examples of metal of the metal ion include Na, K, Li, B, AL, Ti, Ca, Pb, Mn, Co, Zn, Mg, Ce, Ag, Zr, Cu, Fe or Ba), surface active compounds (for example, organic phosphoric acid and salt thereof, e.g., mono-, di- or tri-alkyl phosphate wherein the alkyl group has from 3 to 18 carbon atoms, organic sulfonic acid and salt thereof, e.g., long chain aliphatic sulfonic acid, long chain alkylbenzene sulfonic acid, dialkylsulfosuccinic acid or salts thereof, or amphoteric surface active compound, for example, phosphoripide, e.g., lecithin or cephalin), surfactants having a fluorine atom and/or dialkylsiloxane bond-containing alkyl group, aliphatic alcohols (for example, higher alcohol containing a branched alkyl group having from 9 to 20 carbon atoms, benzyl alcohol, phenethyl alcohol or cyclohexyl alcohol), polyhydric alcohols (for example, alkylene glycol having from 2 to 18 carbon atoms, e.g., ethylene glycol, 1,2-propylene glycol, 1,3-propylene glycol, 1,4-butanediol, neopentyl glycol, 1,6-hexanediol or dodecanediol), alkylene ether glycols having from 4 to 1,000 carbon atoms (for example, diethylene glycol, triethylene glycol, dipropyleneglycol, polyethylene glycol, polypropylene glycol or polytetramethylene ether glycol), alicyclic diols having from 5 to 18 carbon atoms (for example, 1,4-cyclohexanedimethanol or hydrogenated bisphenol A), adducts of alkylene oxide having from 2 to 18 carbon atoms (for example, ethylene oxide, propylene oxide, butylene oxide or α-olefin oxide) with bisphenol having from 12 to 23 carbon atoms (for example, bisphenol A, bisphenol F or bisphenol S), polyols (for example, glycerol, trimethylolethane, trimethylolpropane, pentaerythritol or sorbitol), phenols of three or higher valence (for example, trisphenol PA, phenol novolac or cresol novolac), adducts of alkylene oxide having from 2 to 18 carbon atoms with the above-described polyphenols of three or higher valence (addition molar number: 2 to 20), ether derivatives of the above-described polyhydric alcohol (for example, polyglycol alkyl ether or alkylaryl polyglycol ether), fatty acid ester derivatives of polyhydric alcohol, ether oleate derivatives of polyhydric alcohol (for example, ethylene glycol monoethyl acetate, diethylene glycol monobutyl acetate, propylene glycol monobutyl propionate or sorbitane monomethyl dioxalate), alkylnaphthalenesulfonate, and alkylarylsulfonate, but the invention should not be construed as being limited thereto.

It is preferred that the amounts of various additives are controlled so that the ink composition has a surface tension of from 15 to 60 mN/m and viscosity of from 1.0 to 40 cp at 25° C.

Now, the method for the production of ink composition according to the invention is described below.

According to the invention, the method for the production of oil based ink composition for inkjet printer containing at least a coloring agent and a binder resin in a non-aqueous dispersion medium has the features that the binder resin comprises a copolymer insoluble in the non-aqueous dispersion medium and comprising (a) at least one monofunctional monomer A containing an aliphatic cyclic hydrocarbon group having from 5 to 30 carbon atoms and (b) at least one monofunctional monomer B, which is capable of copolymerizing with the monofunctional monomer A and a homopolymer of which is soluble in the non-aqueous dispersion medium, and that the method includes a step of coating the coloring agent with the binder resin.

Specifically, the coloring agent is coated with the binder resin described above.

Preferably, the method also includes a step of dispersing the colored admixture comprising the coloring agent coated with the binder resin in the non-aqueous dispersion medium.

The oil based ink composition for inkjet printer can be used as oil based ink in various inkjet recording systems. The inkjet recording systems include, for example, a piezoelectric system, inkjet printers of electrostatic system as typified by slit jet of Toshiba Corp. or NTT Corp., etc. and inkjet printers of thermal system.

Preparation examples of the binder resin and examples of the invention will be described below, but the invention should not be construed as being limited thereto.

### PREPARATION EXAMPLE 1 OF BINDER RESIN

### Binder Resin (P-1)

A mixed solution of 90 g of cyclohexyl methacrylate as monomer A, 10 g of octadecyl methacrylate as monomer B and 200 g of toluene was heated to a temperature of 80° C. with stirring under a nitrogen gas stream. To the mixed solution was added 1.0 g of 2,2′-azobis (isobutyronitrile) (abbreviated as AIBN), followed by reacting for 4 hours. Then, 1.0 g of AIBN was added thereto, followed by reacting for 2 hours, and further 0.5 g of AIBN was added thereto, followed by reacting for 2 hours. After cooling, the mixed solution was reprecipitated in 5 liters of methanol, and the resulting powder was collected by filtration and dried to obtain 94 g of white powder. The polymer obtained had a weight average molecular weight (Mw) of 4.2×10⁴. The weight average molecular weight was measured by a GPC method and calculated in terms of polystyrene (hereinafter the same). Binder Resin (P-1) was insoluble in isoparaffinic hydrocarbon (Isopar G (trade name) manufactured by Exxon Chemical Co., hereinafter abbreviated as Isopar G).

### PREPARATION EXAMPLES 2 TO 17 OF BINDER RESIN

### Binder Resins (P-2) to (P-17)

Binder Resins (P-2) to (P-17) were prepared in the same manner as in Preparation Example 1 of Binder Resin except for using the monomers described in Table A below in place of 90 g of cyclohexyl methacrylate and 10 g of octadecyl methacrylate, respectively. The weight average molecular weight (Mw) of each of the binder resins was in a range of from 1.5×10⁴ to 6×10⁴. Each of the binder resins was insoluble or hardly soluble in Isopar G.

TABLE A

| Preparation | | | | | | | |
|---|---|---|---|---|---|---|---|
| Example of | Binder | | | | | | |
| Binder Resin | Resin | Monomer A | | Monomer B | | Monomer C | |
| 2 | P-2 | 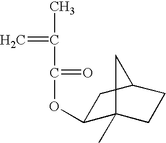 | 90 g | LMA | 10 g | — | |
| 3 | P-3 | 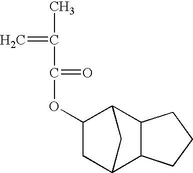 | 90 g | 2EHMA | 10 g | — | |
| 4 | P-4 | 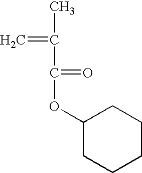 | 70 g | SMA | 10 g | MMA DEMA | 10 g 10 g |
| 5 | P-5 | 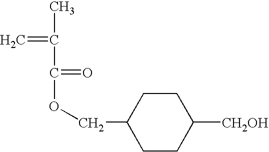 | 60 g | SMA | 20 g | MMA | 20 g |
| 6 | P-6 | 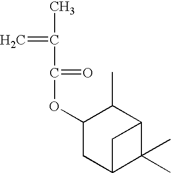 | 50 g | SMA | 30 g | MMA | 20 g |
| 7 | P-7 | 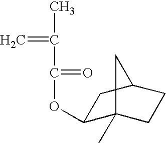 | 70 g | LMA | 10 g | MMA | 20 g |
| 8 | P-8 | 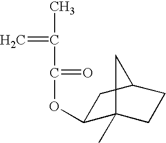 | 50 g | SMA | 20 g | MMA | 30 g |
| 9 | P-9 | 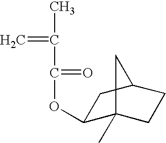 | 60 g | SMA | 10 g | MMA MAA | 20 g 10 g |
| 10 | P-10 | 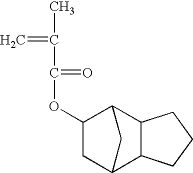 | 60 g | 2EHMA | 20 g | MMA | 20 g |
| 11 | P-11 | 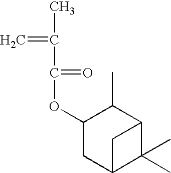 | 60 g | SMA | 10 g | MMA | 30 g |
| 12 | P-12 | 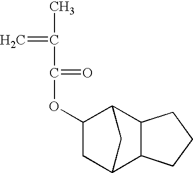 | 60 g | LMA | 10 g | MMA | 30 g |
| 13 | P-13 | 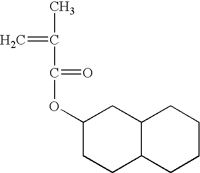 | 70 g | LMA | 10 g | EMA | 20 g |
| 14 | P-14 | 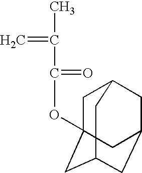 | 70 g | LMA | 10 g | MMA | 20 g |
| 15 | P-15 | 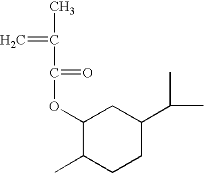 | 70 g | LMA | 10 g | MA DEMA | 10 g 10 g |
| 16 | P-16 | 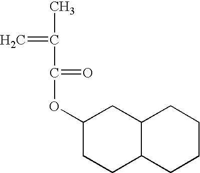 | 60 g | SMA | 10 g | EA MAA | 20 g 10 g |
| 17 | P-17 | 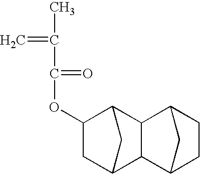 | 70 g | 2EHMA | 10 g | PMA | 20 g |

SMA: Stearyl methacrylate
LMA: Lauryl methacrylate
2 EHMA: 2-Ethylhexyl methacrylate
MMA: Methyl methacrylate
EMA: Ethyl methacrylate
PMA: Propyl methacrylate
MA: Methyl acrylate
EA: Ethyl acrylate
DEMA: N,N-Diethylaminoethyl methacrylate
MAA: Methacrylic acid

### PREPARATION EXAMPLE 1 OF COMPARATIVE BINDER RESIN

### Comparative Binder Resin (R-1)

A mixed solution of 90 g of methyl methacrylate, 10 g of stearyl methacrylate and 200 g of toluene was heated at a temperature of 80° C. with stirring under in a nitrogen gas stream for one hour. To the mixed solution was added 1.0 g of AIBN as a polymerization initiator, followed by reacting for 4 hours. Then, 1.0 g of AIBN was added thereto, followed by reacting for 2 hours, and further 0.5 g of AIBN was added thereto, followed by reacting for 2 hours. The mixed solution was reprecipitated in methanol in the same manner as in Preparation Example 1 of Binder Resin to obtain Comparative Binder Resin (R-1). The weight average molecular weight (Mw) thereof was 3.7×10⁴.

### PREPARATION EXAMPLES 2 TO 5 OF COMPARATIVE BINDER RESIN

### Comparative Binder Resins (R-2) to (R-5)

Comparative Binder Resins (R-2) to (R-5) were prepared in the same manner as in Preparation Example 1 of Comparative Binder Resin 1 except for using the monomers described in Table B below in place of 90 g of methyl methacrylate and 10 g of stearyl methacrylate, respectively. The weight average molecular weight (Mw) of each of the comparative binder resins was in a range of from 1.8×10⁴ to 3.4×10⁴. Comparative Binder Resin (R-5) was easily soluble in Isopar G, and Comparative Binder Resins (R-2) to (R-4) were insoluble in Isopar G.

TABLE B

| Preparation | | | | |
|---|---|---|---|---|
| Example of | | | | |
| Comparative | | | | |
| Binder | Comparative | Comparative | | |
| Resin | Binder Resin | Monomer | Monomer B | Monomer C |
| 2 | R-2 | Benzyl | SMA 10 g | — |
| | | methacrylate | | |
| | | 90 g | | |
| 3 | R-3 | Benzyl | SMA 20 g | MMA 20 g |
| | | methacrylate | | |
| | | 60 g | | |
| 4 | R-4 | Cyclohexyl | — | — |
| | | methacrylate | | |
| | | 100 g | | |
| 5 | R-5 | Cyclohexyl | SMA 90 g | — |
| | | methacrylate | | |
| | | 10 g | | |

### EXAMPLE 1

### Ink Composition (IJ-1)

A mixture of 100 parts by weight of Linol Blue FG-7350 (Pigment Blue 15:3, manufactured by Toyo Ink Mfg. Co., Ltd.) as blue pigment and 100 parts by weight of Binder Resin (P-1) was preliminary pulverized and well mixed in a trio blender, and then melt-kneaded in a three-roll mill heated at 90° C. for 20 minutes. The kneaded pigment mixture was pulverized in a pin mill.

A mixture of 10 parts by weight of the resulting kneaded pigment mixture, 65 parts by weight of Isopar G and 25 parts by weight of a 20 wt % solution prepared by dissolving Dispersant for Pigment (D-1) shown below in Isopar G by heating was blended together with 250 parts by weight of glass beads (3G-X) in a paint shaker (manufactured by Toyo Seiki Co., Ltd.) for 90 minutes. The volume average particle size of pigment resin particles in the resulting dispersion was measured by ultra-centrifugal automatic particle size distribution analyzer (CAPA700 manufactured by Horiba, Ltd.) and it was found to be 0.19 μm, and the pigment resin particles were well dispersed.

Dispersant for Pigment (D-1)

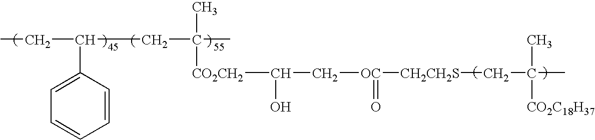

After removing the glass beads by filtration, the above-described dispersion of pigment resin particles was once concentrated by solvent distillation and then diluted with Isopar G to prepare Ink Composition (IJ-1). The ink composition has a concentration of pigment resin particles of 16 wt %, a viscosity of 10 cp (measured by an E type viscometer at a temperature of 25° C., hereinafter the same) and a surface tension of 23 mN/m (measured by an automatic surface tensiometer manufactured by Kyowa Interface Science Co., Ltd. at a temperature of 25° C., hereinafter the same).

Ink Composition (IJ-1) was charged in a color facsimile (SAIYUKI UX-E1CL manufactured by Sharp Corp.) as an inkjet recording device, and an image was drawn on an exclusive use paper of inkjet paper high-grade manufactured by Fuji Photo Film Co., Ltd. As a result, the discharge was stably conducted without causing nozzle clogging. The resulting drawn image was good and clear without blur and the image density thereof was 1.5. Further, a solid pattern was printed, and after drying the print, the solid image portion thereof was rubbed by fingers. As a result, lack of image was not observed at all, so that it was found that the scratch resistance was extremely excellent. The ink composition was free from aggregation and precipitation and extremely good in dispersibility even after preservation for a long period of time.

The evaluation criteria of the ink composition are described below.

<Dispersion Stability of Ink>

After the preparation, the ink composition was allowed to stand at a temperature of 35° C. for one month. A container of the ink composition was shaken by hand several times and particle size (measured by the ultra-centrifugal automatic particle size distribution analyzer CAPA700 manufactured by Horiba, Ltd.) and the presence of aggregate particles were evaluated according to the following criteria:

A: Change in the particle size was not found, and the aggregate particle was not observed at all.

B: The particle size increased somewhat, and small aggregate particles were observed.

C: The particle size largely increased, and many small and large aggregate particles were observed.

<Discharge Stability of Ink>

A: The nozzle clogging did not occur at all after the continuous discharge for 24 hours.

B: The nozzle clogging occurred after two to three hours of the continuous discharge and the discharge was terminated.

C: The nozzle clogging occurred within one hour of the continuous discharge and the discharge was not performed at all.

<Image Quality of Print>

A: The image was good without blur and lack of image.

B: The lack of image was partially observed although the blur was not found.

C: The image was poor due to the occurrence of the blur and lack of image.

<Scratch Resistance>

A: The lack of image upon the rubbing by fingers was not recognized at all.

B: The lack of image upon the rubbing by fingers was slightly recognized.

C: The lack of image upon the rubbing by fingers was readily recognized.

### COMPARATIVE EXAMPLES 1 TO 5

Kneaded pigment mixtures for Comparative Examples 1 to 4 were obtained by conducting the melt-kneading in the same manner as in Example 1 except for using Comparative Binder Resin (R-1) described above, which was an acrylic resin containing no aliphatic cyclic hydrocarbon component, Comparative Binder Resins (R-2) and (R-3) described above each including an aromatic hydrocarbon component, and polyester resin GV-230 (manufactured by Toyobo Co., Ltd.) in place of Binder Resin (P-1) having the aliphatic cyclic hydrocarbon component according to the invention, respectively. For Comparative Example 5, a polyester master batch (Hostacopy C601 (manufactured by Clariant Ltd.) was used as the kneaded pigment mixture. Using the kneaded pigment mixtures, Comparative Ink Compositions (S-1) to (S-5) were prepared in the same manner as in Example 1. The surface tension of each of the ink compositions was adjusted to 23 mN/m, and the viscosity thereof was adjusted in a range of from 10 to 14 cp by controlling the concentration of pigment resin particles. The results of evaluating the characteristics of Comparative Ink Compositions (S-1) to (S-5) are shown in Table C below.

TABLE C

| | Particle | | | | |
|---|---|---|---|---|---|
| | size of | Dispersion | | | |
| | Pigment | Stability | Discharge | Image | Scratch |
| | Resin | of ink | Stability | Quality | Resistance |
| | Particles | Com- | (nozzle | of Drawn | of Drawn |
| | (μm) | position | clogging) | Image | Image) |
| Example 1 | 0.19 | A | A | A | A |
| Comparative | 0.46 | C | C | C | C |
| Example 1 | | | | | |
| Comparative | 0.68 | C | C | C | C |
| Example 2 | | | | | |
| Comparative | 0.73 | C | C | C | C |
| Example 3 | | | | | |
| Comparative | 1.32 | C | C | C | C |
| Example 4 | | | | | |
| Comparative | 1.39 | C | C | C | C |
| Example 5 | | | | | |

From the results shown in Table C it can be seen that in Ink Composition (IJ-1) of Example 1 using the binder resin containing the aliphatic cyclic hydrocarbon component, the pigment resin particles are dispersed in the fine particulate state and the ink composition is excellent in the dispersion stability without the occurrence of aggregation and precipitation even after preservation for a long period of time. On the contrary, in Comparative Ink Compositions (S-1) to (S-5) of Comparative Examples 1 to 5, the coarse pigment resin particles are present, and the severe aggregation occurs during the preservation for a short period of time. With respect to the discharge stability, while that of Ink Composition (IJ-1) of Example 1 was good without the occurrence of nozzle clogging, with Comparative Ink Compositions (S-1) to (S-5) of Comparative Examples 1 to 5, the ink discharge became unstable and the nozzle clogging occurred within one hour of the continuous discharge. With respect to the drawn image by the inkjet recording device, while Ink Composition (IJ-1) of Example 1 provided the clear drawn image of good quality without ink blur, with Comparative Ink Compositions (S-1) to (S-5) of Comparative Examples 1 to 5, the occurrence of blur and lack of image was observed. With respect to the scratch resistance of the drawn image, while Ink Composition (IJ-1) of Example 1 was extremely excellent in the scratch resistance so that the lack of image upon the rubbing by fingers was not observed at all, with Comparative Ink Compositions (S-1) to (S-5) of Comparative Examples 1 to 5, the lack of image was recognized upon the rubbing by fingers.

As described above, it is apparent that the ink composition using the binder resin containing the aliphatic cyclic hydrocarbon component according to the invention is excellent in the dispersion stability due to the fine particulate dispersion of pigment resin particles, is excellent in the discharge stability without the occurrence of nozzle clogging, provides the clear drawn image of good quality without ink blur, and is excellent in the scratch resistance of the drawn image.

### COMPARATIVE EXAMPLES 6 TO 7

Kneaded pigment mixture for Comparative Example 6 was obtained by conducting the melt-kneading in the same manner as in Example 1 except for using Comparative Binder Resin (R-4) described above containing only the polymerization component having an aliphatic cyclic hydrocarbon group in place of Binder Resin (P-1) insoluble in a non-aqueous dispersion medium and containing the polymerization component having an aliphatic cyclic hydrocarbon group and the polymerization component soluble in the non-aqueous dispersion medium according to the invention. Using the kneaded pigment mixture, Comparative Ink Composition (S-6) was prepared in the same manner as in Example 1. In Comparative Example 7, Comparative Binder Resin (R-5) soluble in the non-aqueous dispersion medium and containing the polymerization component having an aliphatic cyclic hydrocarbon group and the polymerization component soluble in the non-aqueous dispersion medium was used. Specifically, a mixture of 10 parts by weight of Linol Blue FG-7350 (Pigment Blue 15:3, manufactured by Toyo Ink Mfg. Co., Ltd.) as blue pigment, 10 parts by weight of Comparative Binder Resin (R-5), 65 parts by weight of Isopar G and 25 parts by weight of a 20 wt % solution prepared by dissolving Dispersant for Pigment (D-1) in Isopar G was blended together with 250 parts by weight of glass beads (3G-X) in a paint shaker (manufactured by Toyo Seiki Co., Ltd.) for 90 minutes, whereby Comparative Ink Composition (S-7) was prepared. The surface tension of each of the ink compositions was adjusted to 23 mN/m, and the viscosity thereof was adjusted in a range of from 10 to 14 cp. The volume average particle size of pigment resin particles in Comparative Ink Composition (S-6) was 0.55 μm and the volume average particle size of pigment particles in Comparative Ink Composition (S-7) was 0.42 μm. The results of evaluating the characteristics of Comparative Ink Compositions (S-6) to (S-7) are shown in

TABLE D

| | Particle | | | | |
|---|---|---|---|---|---|
| | size of | Dispersion | | | |
| | Pigment | Stability | Discharge | Image | Scratch |
| | (Resin) | of ink | Stability | Quality of | Resistance |
| | Particles | Com- | (nozzle | Drawn | of Drawn |
| | (μm) | position | clogging) | Image | Image) |
| Example 1 | 0.19 | A | A | A | A |
| Comparative | 0.55 | C | C | C | C |
| Example 6 | | | | | |
| Comparative | 0.42 | B | C | C | B |
| Example 7 | | | | | |

From the results shown in Table D it can be seen that in Comparative Ink Composition (S-6) of Comparative Example 6 using Comparative Binder Resin (R-4) containing only the polymerization component having an aliphatic cyclic hydrocarbon group, the coarse pigment resin particles are present, and the severe aggregation occurs during the preservation for a short period of time. Further, due to the occurrence of nozzle clogging the discharge defect occurred and the lack of image was observed. With respect to the scratch resistance, the lack of image was recognized upon rubbing the solid image portion by fingers.

On the other hand, in Comparative Ink Composition (S-7) of Comparative Example 7 using Comparative Binder Resin (R-5) soluble in the non-aqueous dispersion medium and containing the polymerization component having an aliphatic cyclic hydrocarbon group and the polymerization component soluble in the non-aqueous dispersion medium, due to the presence of coarse pigment particles the severe aggregation occurs during the preservation for a short period of time. Further, since Comparative Binder Resin (R-5) was soluble in the non-aqueous dispersion medium, the viscosity of the ink composition was higher than that of the invention to make the discharge of ink unstable, whereby the nozzle clogging occurred. On the drawing image, the lack of image occurred. Further, with respect to the scratch resistance of the drawn image, the lack of image was recognized upon rubbing the solid image portion by fingers and it was not satisfactory.

As described above, it is apparent that the ink composition using the binder resin, which is insoluble in the non-aqueous dispersion medium and contains the polymerization component having an aliphatic cyclic hydrocarbon group and the polymerization component soluble in the non-aqueous dispersion medium according to the invention, is specifically excellent in the dispersion stability due to the fine particulate dispersion of pigment resin particles, is excellent in the discharge stability without the occurrence of nozzle clogging, provides the clear drawn image of good quality without ink blur, and is excellent in the scratch resistance of the drawn image.

### EXAMPLE 2

### Ink Composition (IJ-2)

A mixture of 100 parts by weight of Linol Blue FG-7350 (Pigment Blue 15:3, manufactured by Toyo Ink Mfg. Co., Ltd.) as blue pigment and 100 parts by weight of Binder Resin (P-2) was preliminary pulverized and well mixed in a trio blender, and then melt-kneaded in a desktop kneader (PBV manufactured by Irie Firm Co., Ltd.) heated at 120° C. for 120 minutes. The resulting kneaded pigment mixture was pulverized in a pin mill. A mixture of 18 parts by weight of the kneaded pigment mixture, 16 parts by weight of Isopar G and 90 parts by weight of a 20 wt % solution of Dispersant for Pigment (D-1) described in Example 1 in Isopar G was preliminary dispersed together with 250 parts by weight of glass beads (MK-3GX) in a paint shaker (manufactured by Toyo Seiki Co., Ltd.) for 30 minutes, and then subjected wet type dispersion by Dyno-Mill Type KDL (manufactured by Shinmaru Enterprises Corp.) at 3,000 rpm for 2 hours. The volume average particle size of pigment resin particles in the resulting dispersion was 0.16 μm and the pigment resin particles were well dispersed.

Ink Composition (IJ-2) was prepared in the same manner as in Example 1. The surface tension of the ink composition was adjusted to 23 mN/m, and the viscosity thereof was adjusted to 12 cp by controlling the concentration of pigment resin particles. The image drawing characteristics were evaluated in the same manner as in Example 1. The discharge was stably conducted without causing nozzle clogging for a long period of time. The resulting drawn image was good and clear without blur and the image density thereof was 1.5. The scratch resistance in the solid image portion was also excellent. The ink composition was free from aggregation and precipitation and extremely good in dispersibility even after preservation for a long period of time.

### EXAMPLES 3 TO 16

### Ink Compositions (IJ-3) to (IJ-16)

Ink Compositions (IJ-3) to (IJ-16) were obtained by the melt-kneading and wet type dispersion in the same manner as in Example 2 except that each of the binder resins shown in Table E below was used in place of Binder Resin (P-2) and that the temperature for melt-kneading was set 20 to 30° C. higher than the softening point of the binder resin in the temperature range of from 80 to 150° C. The surface tension of each of the ink compositions was adjusted to 23 mN/m, and the viscosity thereof was adjusted in a range of from 10 to 14 cp by controlling the concentration of pigment resin particles. The volume average particle sizes of pigment resin particles in the dispersions of Ink Compositions (IJ-3) to (IJ-16) measured are shown in Table E below. The image drawing characteristics of Ink Compositions (IJ-3) to (IJ-16) were evaluated in the same manner as in Example 2. With each of the ink compositions, the discharge was stably conducted without causing nozzle clogging for a long period of time. The resulting drawn images were good and clear without blur and had the sufficient image density. It was also found that the scratch resistance in the solid image portion was excellent. Ink Compositions (IJ-3) to (IJ-16) were free from aggregation and precipitation and extremely good in dispersibility even after preservation for a long period of time.

TABLE E

| | | Volume Average |
|---|---|---|
| | | Particle Size of |
| | | Pigment Resin |
| Ink Composition | Binder Resin | Particles (μm) |
| IJ-3 | P-3 | 0.19 |
| IJ-4 | P-4 | 0.20 |
| IJ-5 | P-5 | 0.18 |
| IJ-6 | P-6 | 0.18 |
| IJ-7 | P-7 | 0.17 |
| IJ-8 | P-8 | 0.17 |
| IJ-9 | P-9 | 0.21 |
| IJ-10 | P-10 | 0.21 |
| IJ-11 | P-11 | 0.19 |
| IJ-12 | P-12 | 0.16 |
| IJ-13 | P-13 | 0.22 |
| IJ-14 | P-14 | 0.20 |
| IJ-15 | P-15 | 0.17 |
| IJ-16 | P-16 | 0.21 |

### EXAMPLES 17 TO 21

### Ink Compositions (IJ-17) to (IJ-21)

Ink Compositions (IJ-17) to (IJ-21) were obtained in the same manner as in Example 2 except that each of the yellow pigment, red pigments, black pigment and blue pigment shown in Table F below was used in place of the blue pigment, i.e., Linol Blue FG-7350 (Pigment Blue 15:3, manufactured by Toyo Ink Mfg. Co., Ltd.) and that 200 g of Binder Resin (P-4) was used in place of 100 g of Binder Resin (P-2), respectively. The surface tension of each of the ink compositions was adjusted to 23 mN/m, and the viscosity thereof was adjusted to 12 cp. The volume average particle sizes of pigment resin particles in the dispersions of Ink Compositions (IJ-17) to (IJ-21) measured are shown in Table F below.

The image drawing characteristics of Ink Compositions (IJ-17) to (IJ-21) were evaluated in the same manner as in Example 1. With each of the ink composition, the discharge was stably conducted without causing nozzle clogging for a long period of time. The resulting drawn images were good and clear without blur and had the sufficient image density. It was also found that the scratch resistance in the solid image portion was excellent. Ink Compositions (IJ-17) to (JJ-21) were free from aggregation and precipitation and extremely good in dispersibility even after preservation for a long period of time.

TABLE F

| | | Volume Average |
|---|---|---|
| | | Particle Size of |
| | | Pigment Resin |
| Ink Composition | Coloring Agent | Particles (μm) |
| IJ-17 | Toner Yellow HG *1 | 0.18 |
| IJ-18 | Linol Red 6B FG4213 *2 | 0.18 |
| IL-19 | Toner Magenta E02 *3 | 0.19 |
| IJ-20 | Carbon Black MA-8 *4 | 0.16 |
| IJ-21 | Hostabarm Blue B2G *5 | 0.17 |

*1 Pigment Yellow 180 (manufactured by Clariant Ltd.)
*2 Pigment Red 57: 1 (manufactured by Toyo Ink Mfg. Co., Ltd.)
*3 Pigment Red 122 (manufactured by Clariant Ltd.)
*4 Pigment Black 7 (manufactured by Mitsubishi Chemical Corp.)
*5 Pigment Blue 15: 3 (manufactured by Clariant Ltd.)

### EXAMPLE 22

### Ink Composition (IJ-22)

The wet type dispersion was conducted in the same manner as in Example 2 except that a commercially available dispersant for pigment (Solsperse 17000 manufactured by Avecia Ltd.) in place of Dispersant for Pigment (D-1) and that Binder Resin (P-4) was used in place of Binder Resin (P-2). The volume average particle size of pigment resin particles in the resulting dispersion was 0.24 μm. Surface tension and viscosity of the dispersion were adjusted to 23 mN/m and 11 cp respectively to obtain Ink Composition (IJ-22).

The image drawing characteristics of Ink Composition (IJ-22) were evaluated in the same manner as in Example 1. The discharge was stably conducted without causing nozzle clogging for a long period of time. The resulting drawn images were good and clear without blur and had the sufficient image density. It was also found that the scratch resistance in the solid image portion was excellent. Ink Composition (IJ-22) was free from aggregation and precipitation and extremely good in dispersibility even after preservation for a long period of time.

### EXAMPLES 23 TO 25

### Ink Compositions (IJ-23) to (IJ-25)

Ink Compositions (IJ-23) to (IJ-25) were obtained by the wet type dispersion in the same manner as in Example 22 except that each of Dispersants for Pigment (D-2) to (D-4) was used in place of the commercially available dispersant for pigment (Solsperse 17000 manufactured by Avecia Ltd.) and that the surface tension and viscosity were adjusted to 23 mN/m and a range of from 10 to 14 cp respectively. The volume average particle sizes of pigment resin particles in the dispersions of Ink Compositions (IJ-23) to (IJ-25) measured are shown in Table G below. The image drawing characteristics of Ink Compositions (IJ-23) to (IJ-25) were evaluated in the same manner as in Example 1. With each of the ink compositions, the discharge was stably conducted without causing nozzle clogging for a long period of time. The resulting drawn images were good and clear without blur and had the sufficient image density. It was also found that the scratch resistance in the solid image portion was excellent. Ink Compositions (IJ-23) to (IJ-25) were free from aggregation and precipitation and extremely good in dispersibility even after preservation for a long period of time.

TABLE G

| | | Volume Average |
|---|---|---|
| | | Particle Size of |
| | Dispersant for | Pigment Resin |
| Ink Composition | Pigment | Particles (μm) |
| IJ-23 | D-2 | 0.18 |
| IJ-24 | D-3 | 0.17 |
| IJ-25 | D-4 | 0.20 |

Dispersants for Pigment (D-2) and (D-3) have the structures shown below, respectively.

Dispersant for Pigment (D-2)

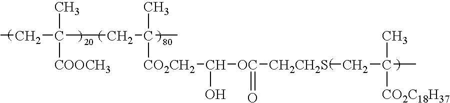

Dispersant for Pigment (D-3)

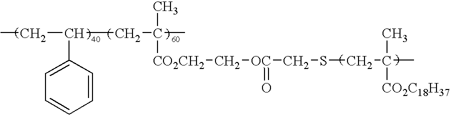

(Copolymerization Ratio is Represented by Weight Ratio)

Dispersant for Pigment (D-4) was prepared in the manner described below.

<Preparation of Dispersant for Pigment (D-4)>

Using a styrene based macromonomer (terminal group: methacryloyl group, number average molecular weight: 6,000) commercially available as AS-6 from Toagosei Co., Ltd., Dispersant for Pigment (D-4) was prepared. Specifically, a mixed solution of 50 g of the styrene based macromonomer (AS-6), 50 g of stearyl methacrylate and 200 g of toluene was put into a four-necked flask and heated to a temperature of 80° C. with stirring under a nitrogen gas stream. To the mixed solution was added 1 g of 1,1′-azobis (1-cyclohexan ecarbonitrile) as a polymerization initiator, follow ed by conducting polymerization at 80° C. for 24 hours. After the polymerization, the reaction mixture was cooled to a room temperature, 200 g of toluene was further added thereto, and reprecipitated in 4 liters of methanol. The white powder collected by filtration was dried to obtain 92 g of a graft copolymer, i.e., [P(stearyl methacrylate)-g-P(styrene)] as powder. The graft copolymer had a weight average molecular weight (Mw) of 7.9×10⁴.

The usefulness of ink composition of the invention as an oil based ink for inkjet printer has been described using the inkjet printer of piezoelectric system, byway of illustration. However, it should be noted that the invention is not limited to be used in such a system, and can also be applied to inkjet printers of electrostatic system as typified by slit jet of Toshiba Corp. or NTT Corp., etc. and inkjet printers of thermal system.

In accordance with the ink composition of the invention using the binder resin containing the polymerization component having an aliphatic cyclic hydrocarbon group and the polymerization component soluble in the dispersion medium, an oil based ink for inkjet printer in which a pigment is uniformly dispersed in the state of fine particle and dispersion stability of the pigment dispersion is excellent can be provided. Also, an oil based ink for inkjet printer, which has high discharge stability free from the occurrence of clogging in a nozzle section, can be provided. Further, an oil based ink for inkjet printer, which has excellent drying property on recording paper, excellent water resistance and light fastness of recorded image, and high-level scratch resistance, can be provided. Moreover, an oil based ink for inkjet printer, which is capable of providing a large number of prints having clear color images of good quality without ink blur, can be provided.

The entire disclosure of each and every foreign patent application from which the benefit of foreign priority has been claimed in the present application is incorporated herein by reference, as if fully set forth herein.

While the invention has been described in detail and with reference to specific embodiments thereof, it will be apparent to one skilled in the art that various changes and modifications can be made therein without departing from the spirit and scope thereof.

What is claimed is:

1. An oil based ink composition for inkjet printer comprising a coloring agent and a binder resin in a non-aqueous dispersion medium, wherein the binder resin comprises a copolymer, which is insoluble in the non-aqueous dispersion medium and comprises (a) a monofunctional monomer A containing an aliphatic cyclic hydrocarbon group having from 5 to 30 carbon atoms and (b) a monofunctional monomer B, which is capable of copolymerizing with the monofunctional monomer A and a homopolymer of which is soluble in the non-aqueous dispersion medium.

2. The oil based ink composition for inkjet printer as claimed in claim 1, wherein the monofunctional monomer A containing an aliphatic cyclic hydrocarbon group having from 5 to 30 carbon atoms is a monomer represented by the following formula (I): 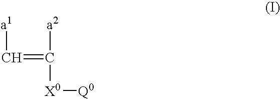
wherein, X^{o} represents a connecting group selected from —COO—, —OCO—, —(CH₂)ₖ—OCO—, —(CH₂)ₖ—COO—, —COO(CH₂)ₖ—, —COO(CH₂O )ₖ—, —CONHCOO—, —CONHCONH—, —O—, and a combination of these groups; k represents an integer of from 1 to 3; a¹ and a², which may be the same or different, each represent a hydrogen atom, a halogen atom, a cyano group, a hydrocarbon group, —COO—Z¹ or —COO—Z¹ connected through a hydrocarbon group; Z¹ represents a hydrogen atom or an hydrocarbon group; and Q⁰ represents an aliphatic cyclic hydrocarbon group having from 5 to 30 carbon atoms.

3. The oil based ink composition for inkjet printer as claimed in claim 1, which further comprises a dispersant for pigment.

4. The oil based ink composition for inkjet printer as claimed in claim 1, wherein the coloring agent is coated with the binder resin to form a colored admixture and the colored admixture has the maximum particle size of not more than 1 μm and an average particle size of from 0.01 to 0.5 μm.

5. Amethod for the production of an oil based ink composition for inkjet printer comprising a coloring agent and a binder resin in a non-aqueous dispersion medium, wherein the binder resin comprises a copolymer, which is insoluble in the non-aqueous dispersion medium and comprises (a) a monofunctional monomer A containing an aliphatic cyclic hydrocarbon group having from 5 to 30 carbon atoms and (b) a monofunctional monomer B, which is capable of copolymerizing with the monofunctional monomer A and a homopolymer of which is soluble in the non-aqueous dispersion medium, and the method includes a step of coating the coloring agent with the binder resin.
